(19) United States
(12) Patent Application Publication
(10) Pub. No.: US 2021/0287635 A1
(43) Pub. Date: Sep. 16, 2021

(54) MODULAR GUITAR WITH WOOD-CORE ELECTRONICS MODULE

(71) Applicant: Aaron Joshua MAISLER, Arlington, VA (US)

(72) Inventor: Aaron Joshua MAISLER, Arlington, VA (US)

(21) Appl. No.: 17/194,737

(22) Filed: Mar. 8, 2021

Related U.S. Application Data
(60) Provisional application No. 62/987,690, filed on Mar. 10, 2020.

(51) Int. Cl. G10D 1/08; G10D 3/02

(52) U.S. Cl. CPC G10D 1/085; G10D 3/02

(57) ABSTRACT

A guitar system includes an acoustics system and an electronics system. The acoustics system includes the head, neck, bridge, and body of a guitar. Typically, guitar strings extend between the head and the bridge. The acoustics system includes a slot for receiving the electronics system. The electronics system includes a base shaped to slideably engage the slot in the acoustics system. The module may be inserted via the (normally floor facing) bottom of the acoustics system. Mounted on the base are electronics include, depending on the module, pickups, a switch for selecting which pickups are active, tone and volume controls, and a jack for receiving a jack for a phone plug of a cable connecting the guitar to a guitar amplifier or the like to provide power to the guitar and return a signal from one or more pickups to the amplifier.

### BACKGROUND

Guitars collectively are the best selling instruments by far worldwide, and the best selling guitars are electric guitars, e.g., with magnetic pickups. The sound of an electric guitar is affected by its body wood, neck wood, fingerboard, pickups, and finish. An electric guitar's pickups are transducers, which means they transfer the vibrational energy of the strings into the electrical signal that drives effects and amplifiers. There are a number of different types of pickups and pickup configurations that have a great influence on a guitar's tone.

A standard pickup is made of a magnetic core wrapped with copper wire. The magnetic core naturally creates a magnetic field, and the vibration of the guitar's strings disturbs that field, resulting in a voltage within the coil. That voltage is ultimately carried out of the guitar through the output jack connected to an amp, direct interface (DI), or pedal board. The number of times the wire is wound around the magnet, the type of the magnet itself, the number of magnets, the adjustability of pole pieces, the distance between the pickup and the strings, and the wiring path all (among other factors) have influence on a pickup's sound.

As its name indicates, a single-coil pickup only has one coil of wire and is noted for producing bright, clean, and transparent tones. One of the drawbacks of single coil pickups is their susceptibility to noise, such as the 60-cycle hum, and electrical interference from sources such as fluorescent lighting when not properly shielded. The humbucking pickup is designed to eliminate transfer of the 60-cycle hum by which single coil pickups can sometimes be plagued. A typical humbucker has two coils wound in reverse, or out of phase from each other—its magnetic poles have flipped polarity for each winding, allowing it to “buck” or cancel the hum. In addition to magnetic pickups, there are piezo-electric pickups and pickups that leverage (electret or condenser) microphone (electret or condenser) technology. Many guitars employ two or more pickups, which may be of the same type of different types.

### BRIEF DESCRIPTION OF THE DRAWINGS

FIG. 1 is a photograph of a guitar system including a humbucker wood-core electronics module.

FIG. 2 is a photograph of the front of an acoustics system of the guitar system of FIG. 1, from which the electronics module has been removed.

FIG. 3 is a photograph of the front of a humbucker wood-core electronics module of the guitar system of FIG. 1.

FIG. 4 is a photograph of the rear of the humbucker wood-core electronics module of FIG. 3.

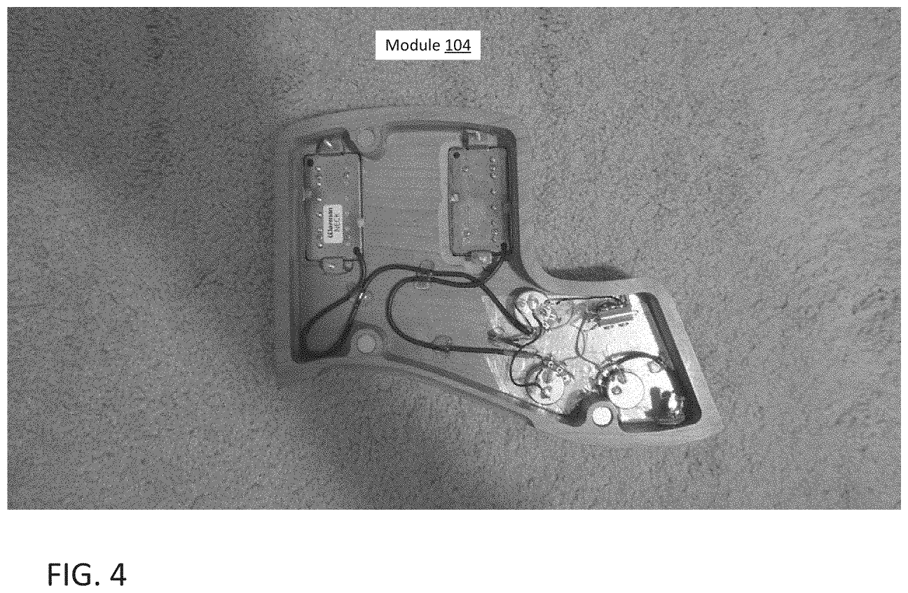

FIG. 5 is a photograph of a mock-up of the guitar system of FIG. 1 showing a module partially inserted or removed from a body of an acoustics system.

FIG. 6 is a photograph of the rear of the guitar system of FIG. 1.

FIG. 7 is a photograph of the bottom (from a player's perspective) of the guitar system of FIG. 1.

FIG. 8 is a photograph of the top of the guitar system of FIG. 1.

FIG. 9 is a photograph of the guitar system of FIG. 1 with an HSS (humbucker-single-single) electronics module installed.

FIG. 10 is a photograph of the front of the HSS electronics module of FIG. 9.

FIG. 11 is a photograph of the rear of the HSS electronics module of FIG. 10.

FIG. 12 is a photograph of the front of a single-coil electronics module insertable in the acoustics system of FIG. 2.

FIG. 13 is a photograph of the rear of the single-coil electronics module of FIG. 12.

FIG. 14 is a photograph of the bottom of the single-coil electronics module of FIG. 13.

FIG. 15 is a photograph of the front of a vintage electronics module insertable in the acoustics system of FIG. 2.

FIG. 16 is a photograph of the rear of the vintage electronics module of FIG. 15.

FIG. 17 is a bottom perspective photograph of a portion of the body of the acoustics system of FIG. 2 showing a detail of the slot into which electronics modules are inserted.

### DETAILED DESCRIPTION

The present invention provides a guitar system with an acoustics system that defines a slot into which an electronics module can be inserted and from which an electronics module can be removed. The acoustics system includes the head, neck, bridge, and body of a guitar. Typically, guitar strings extend between the head and the bridge. The acoustics system includes a slot for receiving electronics modules, each of which can include one or more pickups in various configurations and using various pickup technologies, e.g., single-coil, Humbucker, piezo-electric, etc. The pickup or pickups can be mounted on a module base or “core”, which advantageously can be of wood to acoustically match wood components of the acoustic system. Herein, “wood” encompasses natural wood and wood-based products, such as plywood and simulated wood.

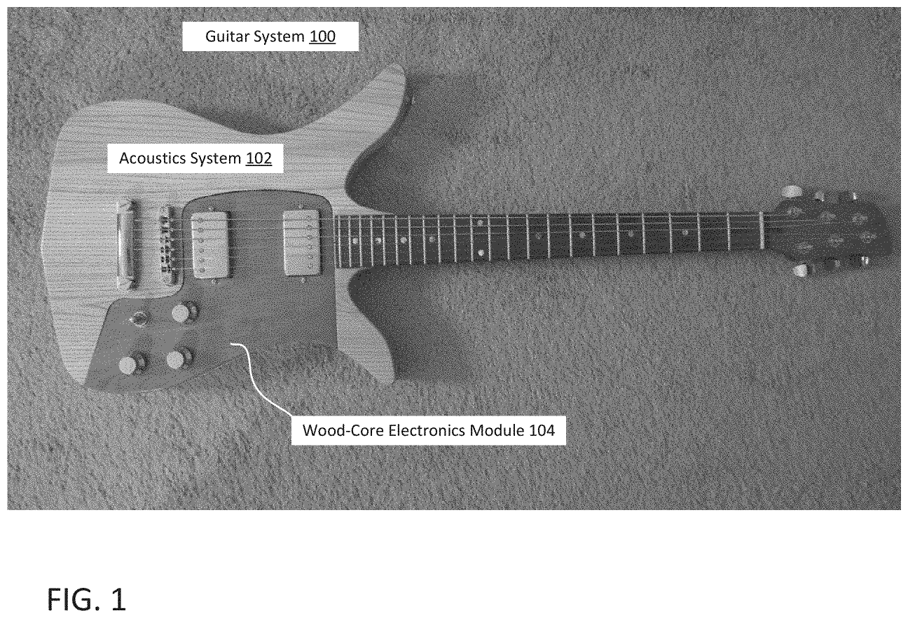

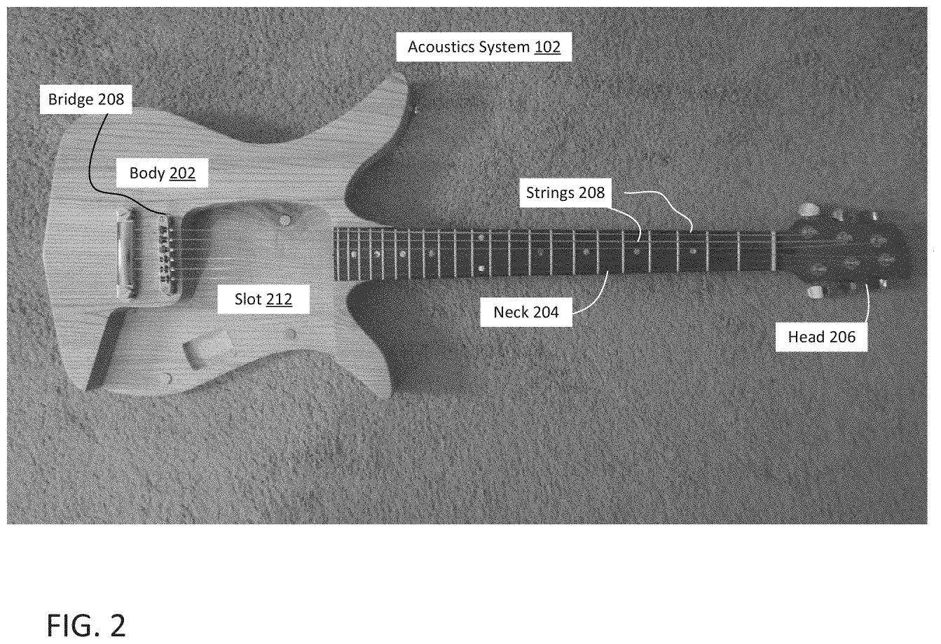

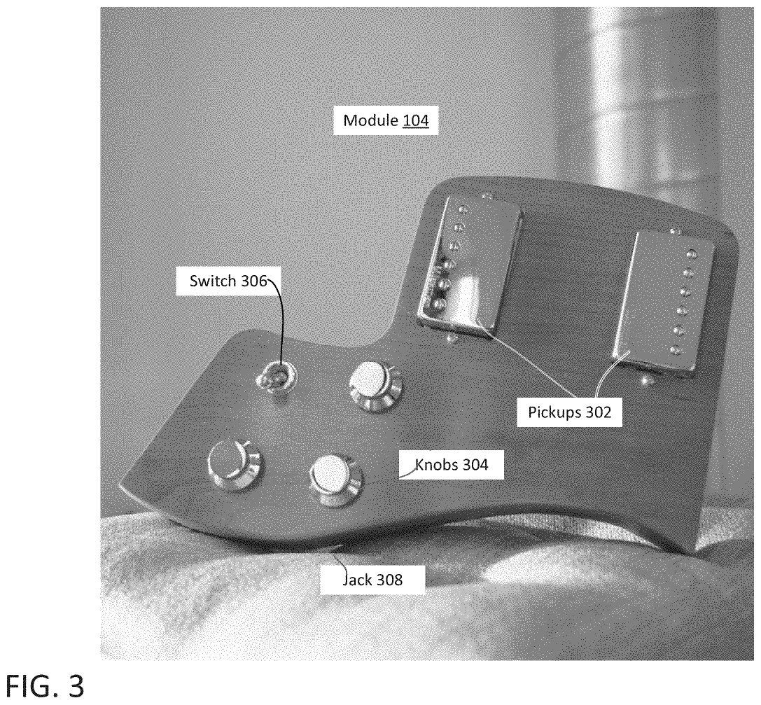

As shown in FIG. 1, a guitar system 100 includes an acoustics system 102 and a wood-core electronics module 104. As shown in FIG. 2, acoustics system 102 includes a body 202, a neck 204, a head 206, strings 208 and a bridge 210. Body 202 defines a slot 212 for receiving a wood-core electronics module. As shown in FIGS. 3 (front) and 4 (rear, module 104 includes two humbucker pickups 303, three potentiometer knobs 304, a toggle switch 306, and a quarter-inch jack 308. Note that module 104 is shaped to conform to slot 212 (FIG. 2).

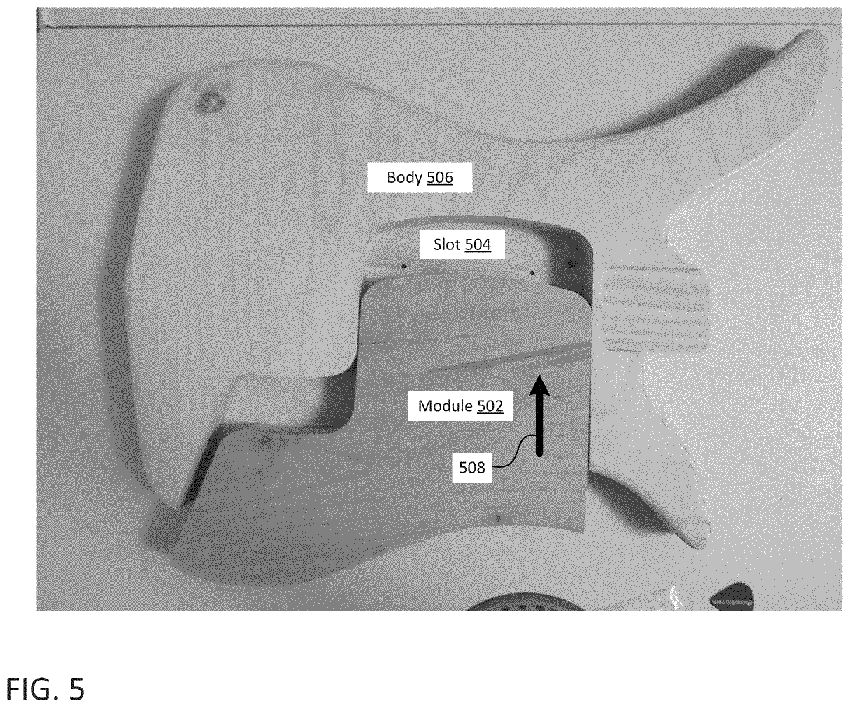

A blank electronics module 502 is shown in FIG. 5 partially inserted into a slot 504 of a body 506. An arrow 508 shows the direction of insertion from the bottom of slot 504.

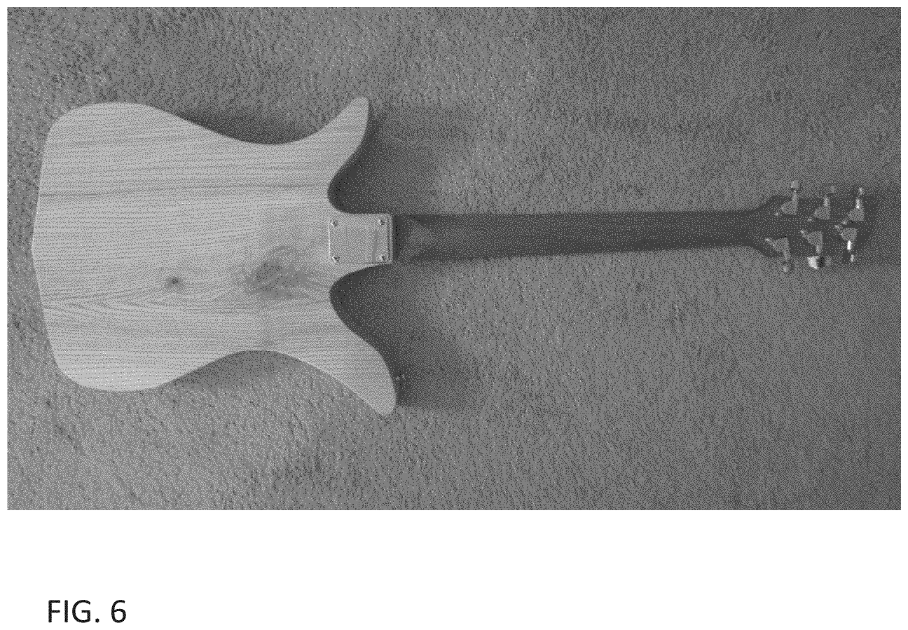

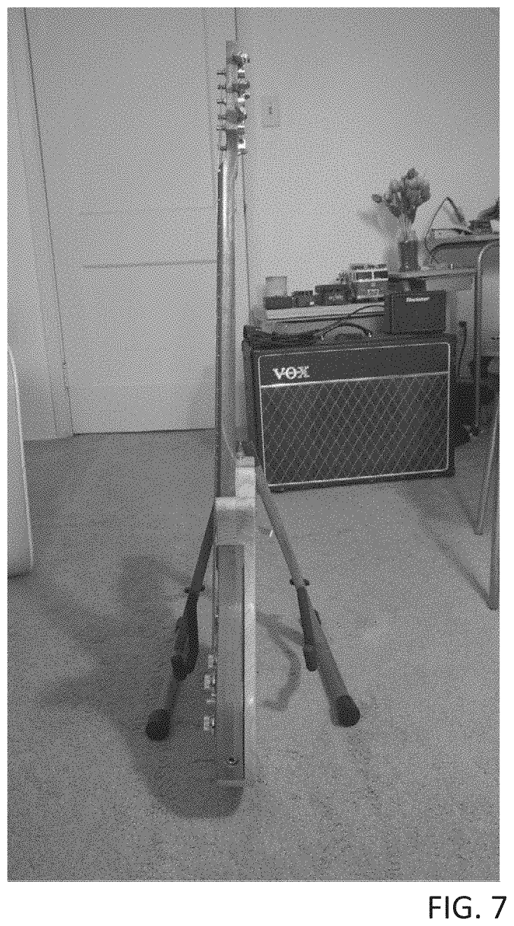

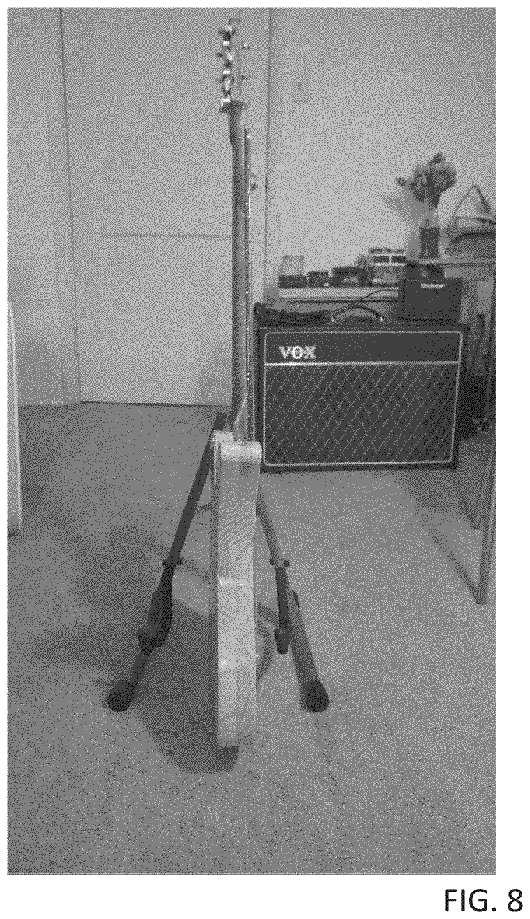

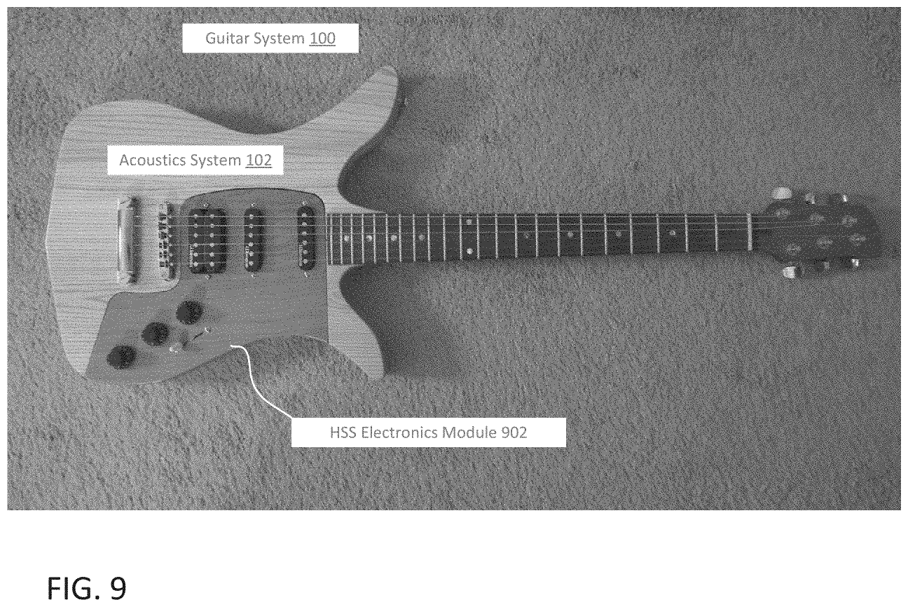

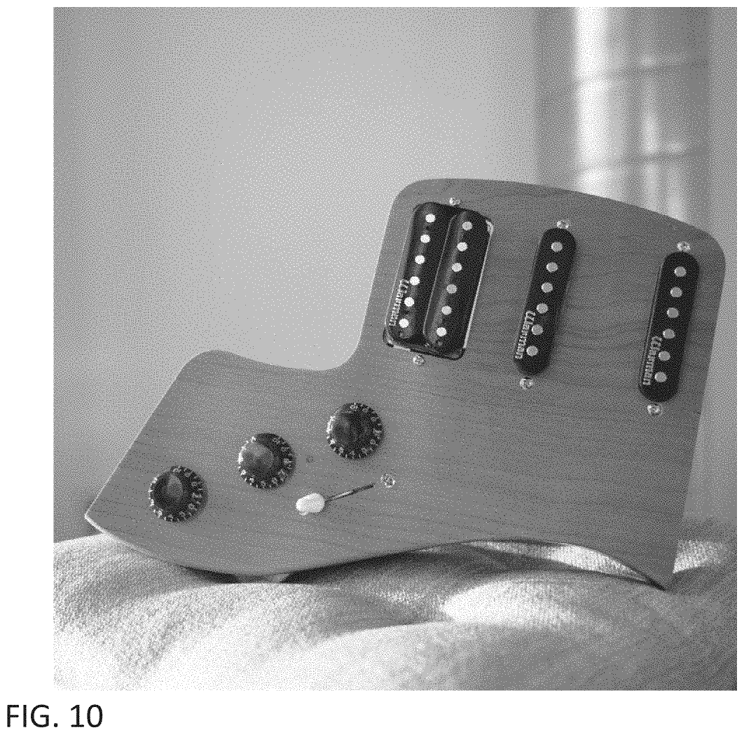

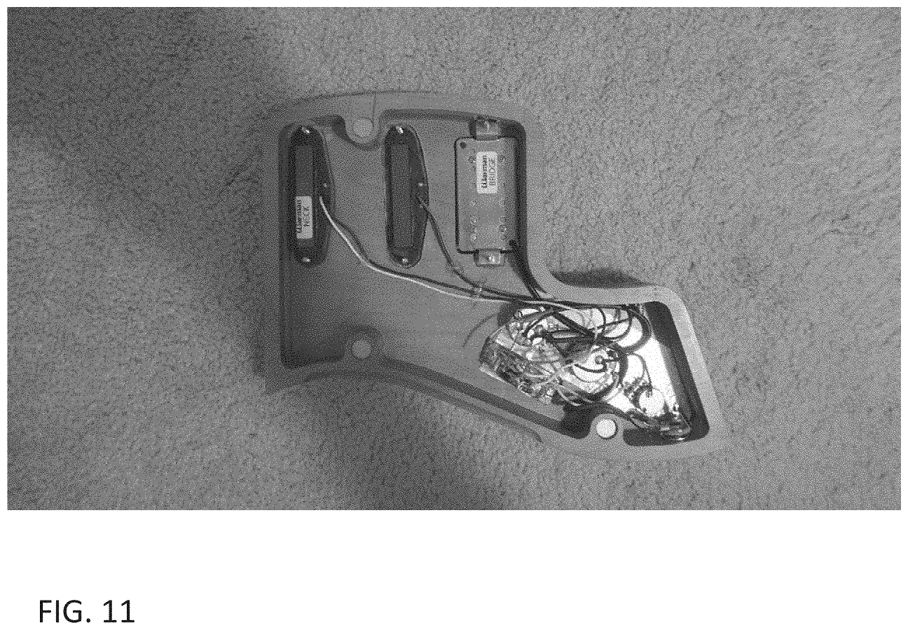

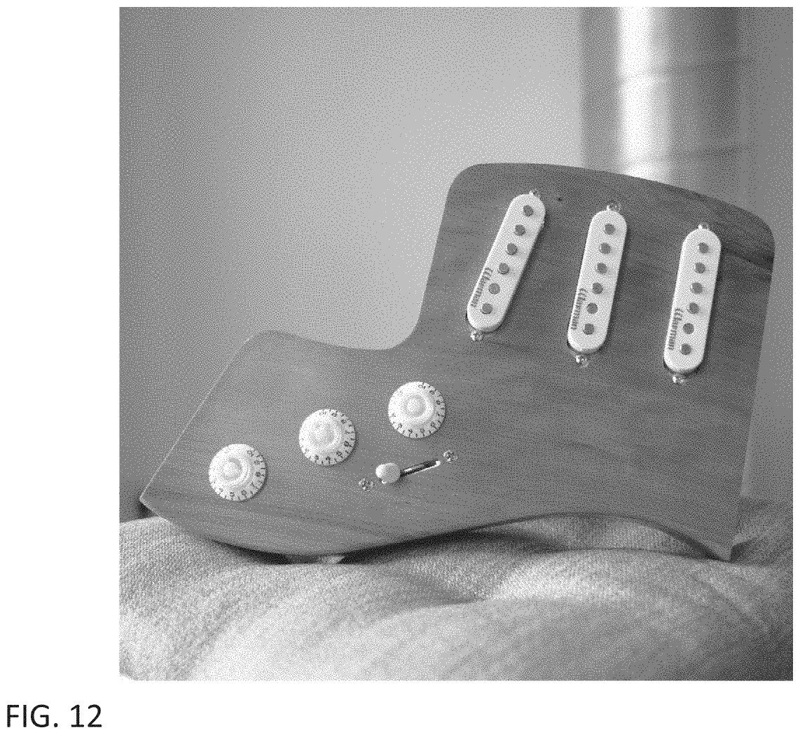

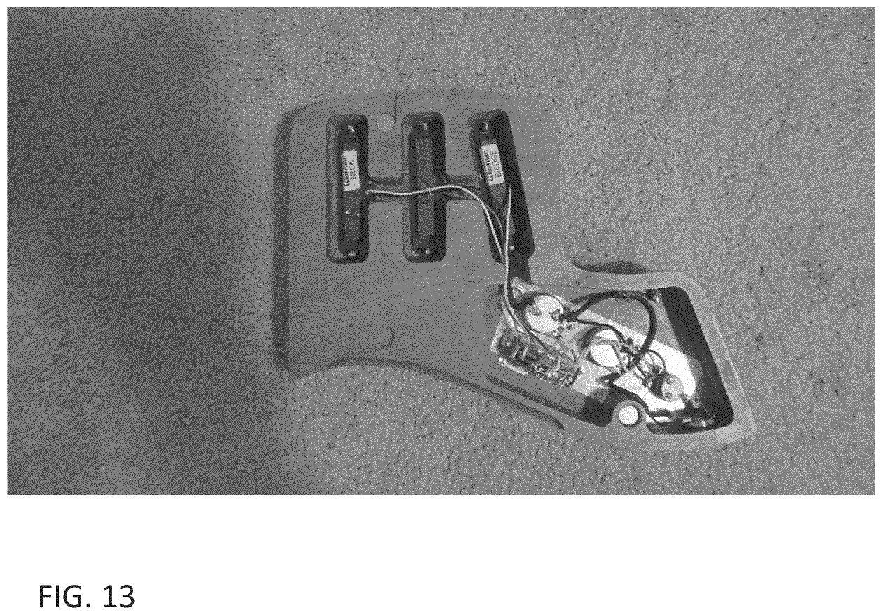

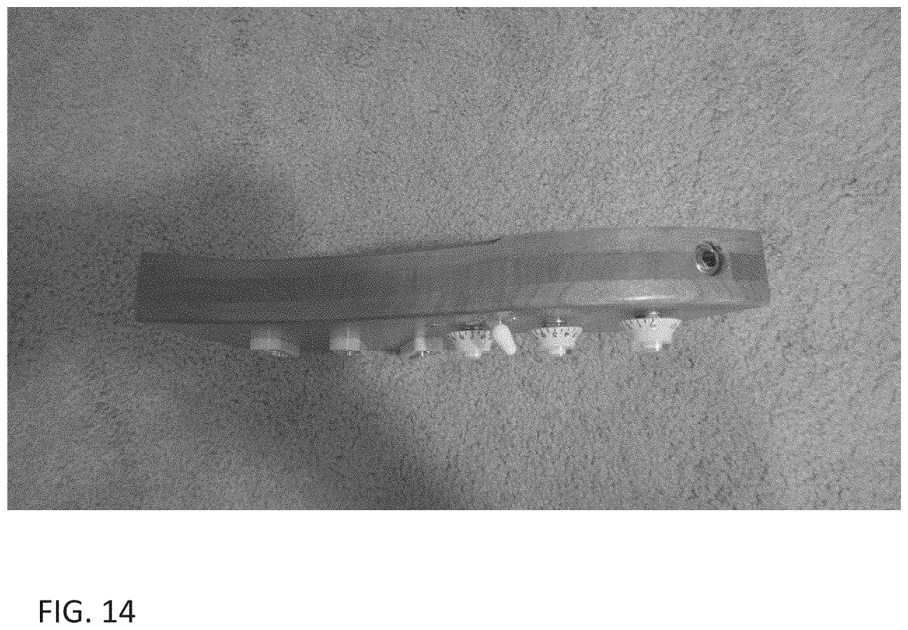

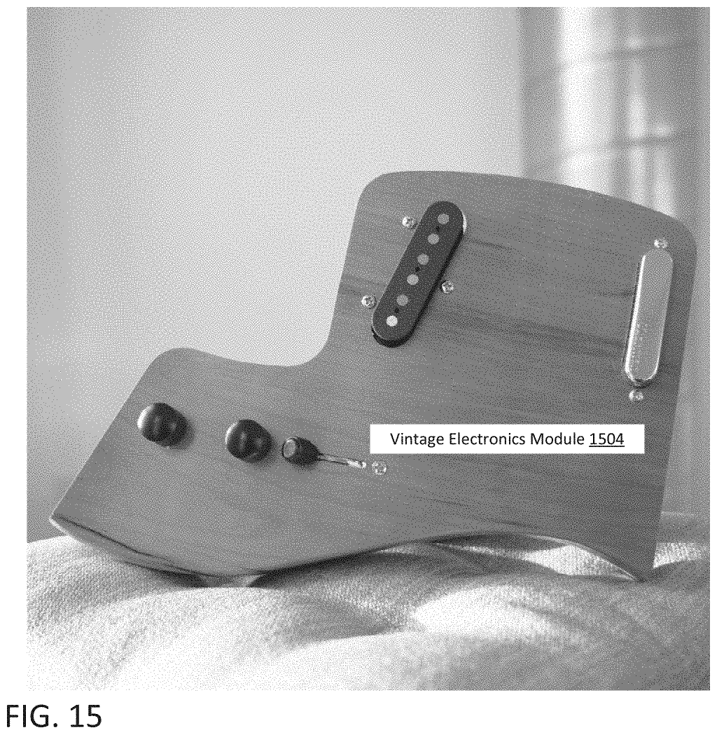

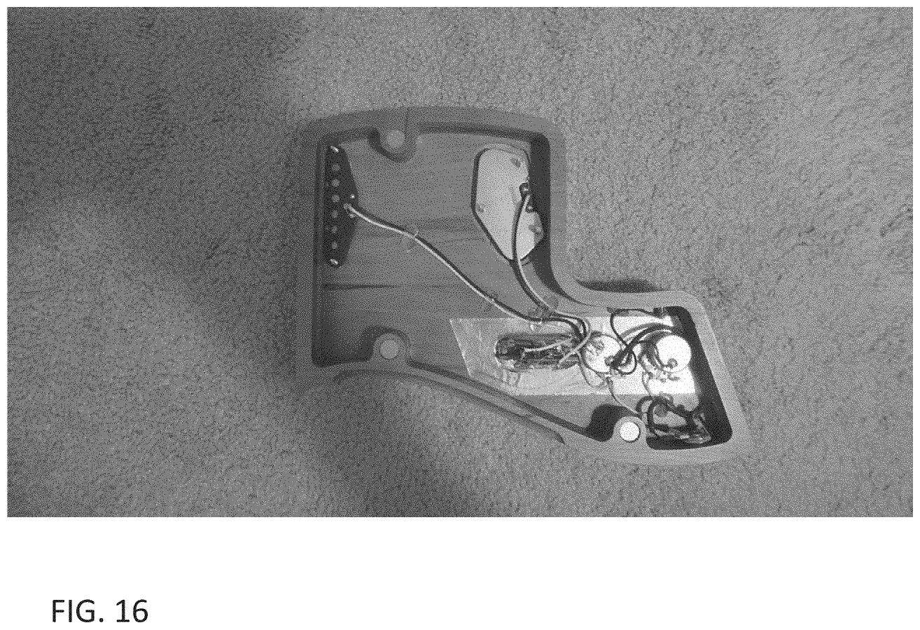

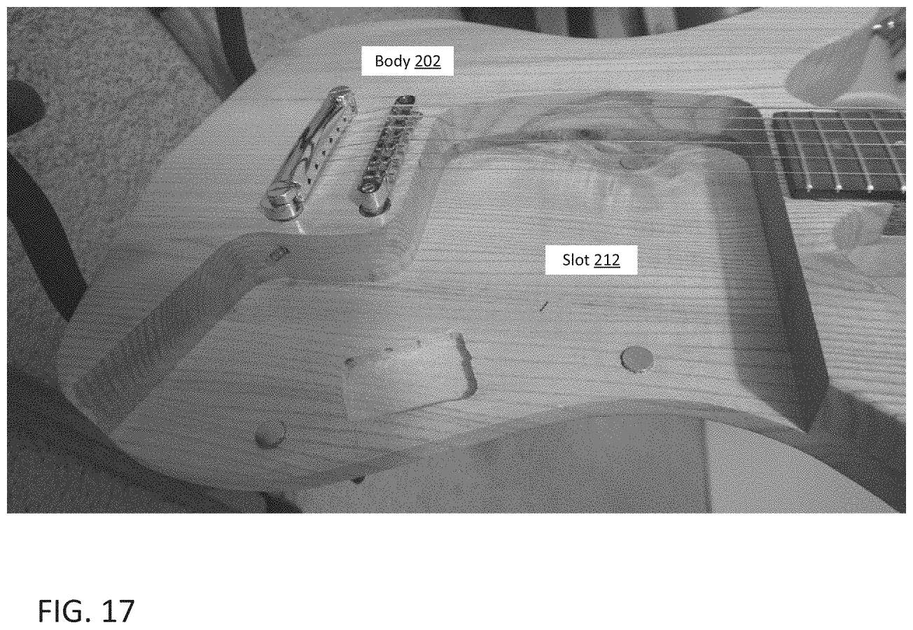

FIGS. 6-8 respectively show rear, bottom and top views of guitar system 100. FIG. 9 shows guitar system 100 with a different (HSS) wood-core electronics module 902 installed in acoustics system 102. FIGS. 10 and 11 respectively show front and rear views of humbucker-single-single (HSS) electronics module 902. FIGS. 12-14 respectively show front, rear, and bottom views of a single (SSS) electronics module 1202, insertable into slot 212 of body 202. FIGS. 15 and 16 respectively show front and rear views of a vintage module 1502. FIG. 17 is a close up of slot 212 in body 202.

Each electronics module includes a base shaped to slideably engage the slot in the acoustics system. The module may be inserted via the (normally floor facing) bottom of the acoustics system. Not shown, but mounted on the base are electronics may include, depending on the module, pickups, a switch for selecting which pickups are active, tone and volume controls, and a jack for receiving a jack for a phone plug of a cable connecting the guitar to a guitar amplifier or the like to provide power to the guitar and return a signal from one or more pickups to the amplifier. These items all appear on a front side of the base. Routing between these elements can be along a (player facing) backside of the base.

When the electronics system is inserted into the slot, its front (audience facing) face is coplanar (to within a +1 mm (millimeter) tolerance) with a front face of the guitar body to define a continuous top surface for the guitar. The continuous top surface can enhance resonant interaction with vibrating strings yielding what for many is a pleasing acoustic tone. In addition, the absence of a height difference between the body front and the electronics base front reduces the likelihood that a finger or pick may be snagged at their boundary.

The depth of the slot may be between 1.0″ (≈2.5 centimeters (cm)) and 1.5 inches (≈3.8 cm). The thickness of the electronics base may closely match the depth of the slot for a snug fit or may be somewhat less to allow clearance for electrical connections among the controls on the front face of the base. In the latter case, the base may include ridges that engage grooves in the slot sidewalls to ensure coplanarity of the front faces of the base and the guitar body. The base and the body (and some other components) can be made of wood, which many players prefer for its tonal qualities and its traditional role in guitar history.

The modular guitar system offers multiple pickup and control configurations while still keeping the feel of a traditional electric guitar.

Modules can be swapped in seconds, without the need to disassemble or change strings. Portability is a key factor in our design—each module boasts the functionality of a full guitar, yet can easily fit into a backpack.

Modules can implement various pickup and control schemes.odular guitars are defined by their removable pickup assemblies. Traditionally, guitarists have had to change guitars when seeking different tones from different electronics. Isolating the electronics to a single removable module allows for an unlimited number of pickup and control configurations from a single guitar. This is both cheaper and more flexible than traditional configurations.

Embodiments of the invention use a wood core to house all electrical components. The wood assembly offers a wide flexibility in materials when choosing modules, including most popular tone woods. Wood allows for maximum flexibility in the electronics modules and offers a richer tone than metal or plastic modules. Different module can be made out of most kinds of tone wood to accommodate a wide range of custom specifications.

The body can be made from any kind of wood, and aside from the modular apparatus, nothing about it is proprietary. Blank modules (left) can be available in a variety of materials so customers can customize.

In one embodiment, a user can switch between two modules that are electronically identical (same pickup types and configurations), but differ only in the type of wood used for the core. Thus, the only affect on sound is due to the change of wood type.

While, in the embodiments discussed above, the contemplated switch involves switching electronics modules to be used with an guitar acoustics system (including head, neck, strings, and bridge), the present invention also provides for switching acoustics systems to be used with a module. For example, acoustics systems of different sizes, geometries, and wood types could be used (at different times) with the same electronics module.

Herein, all art labeled “prior art”, if any, is admitted prior art; all art not labelled “prior art”, if any, is not admitted prior art. The illustrated and described embodiments, as well as modifications thereto and variations thereupon are provided for by the present invention, the scope of which is defined by the following claims.

What is claimed is:

1. An electric guitar system comprising:
an acoustics system including a guitar head, a guitar neck, a guitar body, and a guitar bridge; and
a first electronics module including a first module core and at least one pickup mounted in the first module core, the acoustics system and the electronics module being co-configured so that the first electronics module can be inserted into and removed from the acoustics system even while guitar strings extend from the guitar head to the guitar bridge.

2. The guitar system of claim 1 wherein the first electronics module core is wood.

3. The electric guitar system of claim 1 further comprising a second electronics module that can be inserted into the acoustics system when the first electronics module is not inserted into the acoustics system.

4. The electric guitar system of claim 3 wherein the first electronics module includes a first configuration of pickups and the second electronics module includes a second configuration of pickups that is different from the first configuration.

5. The electric guitar system of claim 3 wherein the first module core is made of a first wood type and the second electronics module includes a second core made of a second wood type different from the first wood type.

6. The electric guitar system of claim 3 wherein the first electronics module includes a first configuration of pickups and the second electronics module includes a second configuration of pickups that is the same as the first configuration.
